(19) United States
(12) Patent Application Publication
(10) Pub. No.: US 2011/0018622 A1
(43) Pub. Date: Jan. 27, 2011

(54) Simple noise control method

(76) Inventor: Vuong Binh Hong, Costa Mesa, CA (US)

Correspondence Address: VUONG BINH HONG, 3132 COOLIDGE AVE, COSTA MESA, CA, 92626, US

(21) Appl. No.: 12/460,882

(22) Filed: Jul. 27, 2009

(51) Int. Cl. H04B 1/10

(52) U.S. Cl. 327/551

(57) ABSTRACT

The Simple Noise Control Method is a method used to eliminate all noise from a pulsed signal. By subjecting the pulsed signal to a band pass filter and duration filter based on simple, low cost and widely available timers, counters and logic gates or equivalents, any noise in the pulsed signal which have different frequencies or durations than the signal can be removed with very high certainty.

The Simple Noise Control Method is a method used to control the noise in a circuit which uses pulsed signals as a means of communication. This method utilizes regular timers, counters and logic IC's to prevent noises in signal from affecting the circuit. The timers and counters create a frequency band pass filter and duration filter which will virtually render the circuit noise free.

The band pass filter eliminates all noises below and above a minimum and maximum frequency limits in which the signal frequency is well within or near the middle of the limits.

The duration filter eliminates all noises which frequencies are within the pass band but their lives are shorter or longer than certain time limits in which the signal is supposed to be within.

The band pass filter can be modified very easily to become high pass filters to use in a case the noises' frequencies are low. The duration filter can also be modified as such easy to become a long duration filter which filters out noises which have lives shorter than the minimum time duration of the window. After these two filters, the noises are virtually eliminated and the circuit is noise free.

### REFERENCE

| | | |
|---|---|---|
| 5,049,763 | Sep. 17, 1991 | Rogers |
| 6,175,598 | Jan. 16, 2001 | Yu, et al. |

U.S. Pat. No. 5,049,763, Rogers, Sep. 17, 1991, discloses a ground noise detector circuit which can detect the ground noise caused by the power supply and takes proper action to reduce the damage caused by the noise. However, the Rogers, 1991 circuit has the disadvantages of not detecting and protecting the device from noises come from other sources such as surrounding or spike.

U.S. Pat. No. 6,175,598, Yu, et al., Jan. 16, 2001, discloses an output noise control scheme for multiple I/O's which can significantly reduce power ground bounce characteristics when multiple outputs being simultaneously switched. However, the Yu, et al, 2001 circuit has the disadvantages of not detecting and protecting the circuit from noises come from other sources such as spike which can falsely change the operation of the circuit.

### BACKGROUND OF THE INVENTION

Interference from noise is a major problem for almost all electronic circuits. Noise can come from a variety of sources, including the surrounding environment, the power supply, the spike on the electrical network especially from inductance device connected to the same electrical conductors. Some devices can tolerate certain levels of noises; however, some devices cannot tolerate even a single noise which might effect its operation. A touchless switch which mistakenly turns on the light while people are sleeping is not acceptable.

There are many methods to control and to eliminate noises such as noise suppressor diode to limit the Voltage of the spike, a time delay circuit to wait out the noise or use of software algorithms to eliminate noise. However, noises are unpredictable and everywhere. It is costly to contain noises and sometimes it is almost impossible to avoid them.

The present invention will control the noise in a circuit which uses pulsed signals as an operation media. One typical application, but not limited to, is a touchless switch using pulsed infrared (IR) signals to control the switch. If a person reflects an IR beam to the receiver, the switch will toggle. There are many sources of noises: the sun, light and human, devices. Noise control is critical for a touchless switch.

The present invention uses a few simple, low cost and widely available integrated circuits such as timers, counters, logic gates and flip flops to control the noises in the circuit. For the example of a touchless switch, the IC's required to control the noises are just two timers and two counters, with which they can protect the switching circuit and keep it virtually free of noise.

### BRIEF DESCRIPTION OF THE SEVERAL VIEWS OF THE DRAWING

The above and other aspects, features and advantages of the present invention will be more apparent from the following more particular description presented in conjunction with the following drawings wherein:

FIG. 1 shows the block diagram of the typical frequency filter circuit. The duration filter circuit is exactly the same except the length of the wave form is much longer.

FIG. 2 shows the block diagram of a typical high pass filter circuit and long duration pass filter circuit and the flip flop as the memory cell for a simple circuit such as touchless switch circuit.

### DETAILED DESCRIPTION OF THE INVENTION

The following description is of the best version presently contemplated for carrying out the invention. This description is not to be taken in a limiting sense, but is made merely for the purpose of describing one or more preferred embodiments of the invention. The scope of the invention should be determined with reference to the claims.

The present invention provides a simple but effective method to control the noises introduced into the signal at the input of the circuit by the surrounding environment or power supply.

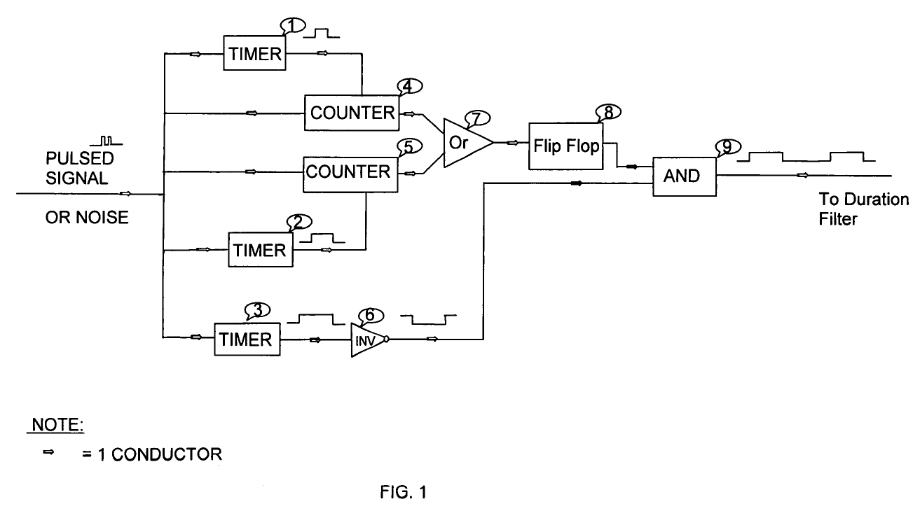

From FIG. 1 three timers 1, 2 and 3 generate three pulses: one short, one long and one longest. The difference between the short and long pulses depends on the consistent frequency of the signal but it cannot be equal or longer than the short pulse for proper operation. If the signal frequency is highly constant then the difference is small and vice versa. These two pulses enable counters 4 and 5 at high state and clear the two counters 4 and 5 at low state. Three timers 1, 2 and 3 are triggered by the same signal pulse to start the three pulses almost at the same time.

Counters 4 and 5 count the pulses of the signal within the short and long periods of time generated by timers 1 and 2, respectfully. Because the frequency of the signal is known within certain limits, the length of the pulse from timer can be calculated such that counter 4 will count to certain number and clock the flip flop 8 only if the frequency of the signal is equal or higher than the minimum frequency of the signal. Thus this will eliminate all noise which has frequencies lower than the minimum frequency of the signal. Counter 4 works as a high pass filter. On the other hand, counter 5 is supposed NOT to count to certain number at the end of the pulse. If counter 5 reaches certain number within the length of the long pulse, the frequency of the signal (actually noise) is higher than the maximum frequency of a good signal. If this happens, counter 5 will toggle flip flop 8 again thus canceling out the effect of counter 4. As a result, counter 5 works as a low pass filter. Or gate 7 is used to connect two outputs of counter 4 and 5 to the clock input of flip flop 8. During the longest pulse, the output of flip flop 8 is rendered unable by the use of inverter 6 combined with and gate 9. At the end of the longest pulse, and if the flip flop 8 changes its states, the frequency of the signal will be within certain limit of the band pass and the signal is good.

However, because some noises can have frequencies comparable to the good signal, the output of flip flop 8 is needed to run under another filter: the duration filter.

The duration filter which is the same as the band pass filter is comprised of three timers, two counters, one flip flop, one and, one or and one inverter gates. The operation of the duration filter is exactly the same as the operation of the band pass filter; however, the duration filter is based on how long the signal is kept under test, not the frequency. Noise which duration is shorter or longer than the supposed duration of the signal will be eliminated. Usually, noise's duration is short but the long pulse test can be used to eliminate the chance of a false trigger, such as someone standing in front of a touchless switch for a long period of time.

The output of the flip flop of the duration filter can be used to turn on or off an apparatus such as a lamp, faucet etc, without worrying about noises in the input signal.

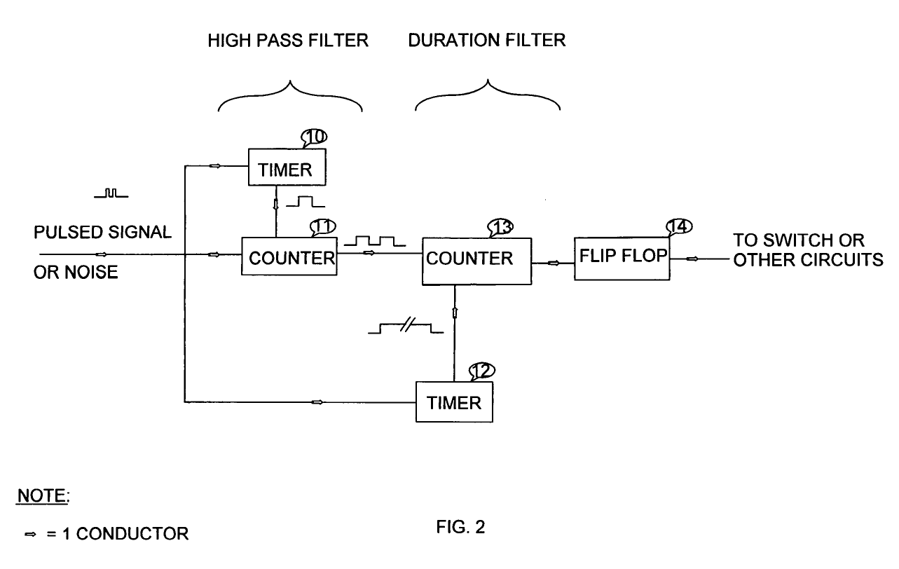

FIG. 2 shows the block diagram of a reduced Simple Noise Control Method circuit. A high pass filter and long duration filter can be used instead of the band pass filter and the duration filter to filter out the noises. In this case, only one timer 10 and one counter 11 are needed for the high pass filter and timer 12, counter 13 are needed for the long duration filter. Flip flop 14 is used to remember the state of the circuit. Because the nature of noise is either fast and short or slow and long, a high pass filter and a long duration filter can be used effectively to eliminate all noises for a switch circuit or other devices. The combination of many of these filters can create a machine in which noises are effectively avoided.

What I claim is:

1) A Simple Noise Control Method: a method that virtually eliminates all noise in a pulsed signal by using a band pass filter and a duration filter to filter out the noises.

2) The Simple Noise Control Method of claim 1, wherein the band pass filter and duration filter are comprised of timers, counters and logic gates.

3) The Simple Noise Control Method of claim 2, wherein the band pass filter is built by using three timers, two counters, one Or gate, one And gate, and one inverter.

4) The Simple Noise Control Method of claim 3, wherein the three timers generate three pulses of different length, one short, one long and one which is the longest. The difference between the short and long pulses depends on the consistent frequency of the signal but it cannot be equal or longer than the short pulse for proper operation. If the signal frequency is highly constant then the difference is small and vice versa. The two counters are chosen such that these two pulses enable the two counters when the pulses are at high state and clear the two counters at low state. The three timers are triggered by the same signal pulse to start the three pulses almost at the same time.

5) The Simple Noise Control Method of claim 4, wherein the two counters count the pulses of the signal within the short and long periods of time generated by the two timers. Because the frequency of the signal is known within certain limits, the length of the pulse from the timer of the short pulse (short timer) can be calculated as such that the short counter will count to certain number and clock the flip flop only if the frequency of the signal is equal or higher than the minimum frequency of the signal. This will eliminate all noises which have frequencies that are lower than the minimum frequency of the signal. The short counter works as a high pass filter. On the other hand, the counter of the long pulse (long counter) is supposed to NOT count to certain number at the end of the pulse. If the long counter reaches a certain number within the length of the long pulse, the frequency of the signal (actually noise) is higher than the maximum frequency of the good signal. If this happens, the long counter will toggle the flip flop again thus canceling out the effect of the short counter. In short, the long counter works as a low pass filter. During the longest pulse, the output of the flip flop is rendered unable by the use of an inverter and an and gate. At the end of the longest pulse, if the flip flop changes its state, it means that the frequency of the signal is within certain limit of the pass band. However, because some noises can have frequencies within the frequency limits, the output of the flip flop will need to be run under another filter, the duration filter.
The duration filter comprises the same components as the band pass filter: three timers, two counters, one flip flop, one And gate, one Or gate and one inverter gate. The operation of the duration filter is similar to the operation of the frequency pass band filter; however, the duration filter is based on how long the signal is kept running not the frequency. As a result, the noises existing for a period time which is shorter or longer than the proper duration of the signal will be eliminated. Usually, the noises are short but the long pulse test can be used to eliminate the chance of a false trigger such as someone standing in front of a touchless switch for a long period of time.

7) The Simple Noise Control Method of claim 1, wherein the output of the flip flop of the duration filter can be used as a memory of a switch and it can turn on or off an apparatus such as a lamp, faucet etc. without worry about noise.

8) The Simple Noise Control Method of claim 1, wherein a high pass filter and long duration filter can be used instead of a band pass and a duration filters to filter out the noises. In that case, only one timer and one counter are needed for each high pass filter or long duration filter. Because noise is either fast and short or slow and long, a high pass filter and a long duration filter can be used effectively eliminate all noises from circuits or other uses. The combination of many of these filters can create a machine free of noise.
